(19) United States
(12) Patent Application Publication
(10) Pub. No.: US 2006/0168584 A1
(43) Pub. Date: Jul. 27, 2006

(54) Client controlled monitoring of a current status of a grid job passed to an external grid environment

(75) Inventors: Christopher J. Dawson, Arlington, VA (US); Rick A. Hamilton II, Charlottesville, VA (US); Steven J. Lipton, Flower Mound, TX (US); James W. Seaman, Falls Church, VA (US)

Correspondence Address: IBM CORPORATION ENDICOTT;c/o AMY J. PATTILLO, P.O. BOX 161327, AUSTIN, TX, 78716, US

(73) Assignee: International Business Machines Corporation, Armonk, NY (US)

(21) Appl. No.: 11/014,400

(22) Filed: Dec. 16, 2004

(51) Int. Cl. G06F 9/46

(52) U.S. Cl. 718/104

(57) ABSTRACT

A method, system, and program for client controlling monitoring of a current status of a grid job passed to an external grid environment are provided. A grid client generates a job status query for a grid job passed to an external grid environment. Next, the grid client sends the job status query to the external grid environment via a communication portal. The external grid environment initiates a grid job tracking agent for determining the grid job status within the external grid environment and providing a status response to the grid client. Responsive to receiving the current status from the grid job from the external grid environment, the grid client determines whether the current status meets the expected performance for the grid job, such that the grid client is enabled to monitor whether the external grid environment is actually executing the grid job within the constraints of the expected performance.

### BACKGROUND OF THE INVENTION

1. Technical Field

The present invention relates in general to improved grid computing and in particular to monitoring a current status of a job executing within an external grid environment. Still more particularly, the present invention relates to enabling a grid client to monitor the real-time status of jobs passed to an external grid environment.

2. Description of the Related Art

Ever since the first connection was made between two computer systems, new ways of transferring data, resources, and other information between two computer systems via a connection continue to develop. In typical network architectures, when two computer systems are exchanging data via a connection, one of the computer systems is considered a client sending requests and the other is considered a server processing the requests and returning results. In an effort to increase the speed at which requests are handled, server systems continue to expand in size and speed. Further, in an effort to handle peak periods when multiple requests are arriving every second, server systems are often joined together as a group and requests are distributed among the grouped servers. Multiple methods of grouping servers have developed such as clustering, multi-system shared data (sysplex) environments, and enterprise systems. With a cluster of servers, one server is typically designated to manage distribution of incoming requests and outgoing responses. The other servers typically operate in parallel to handle the distributed requests from clients. Thus, one of multiple servers in a cluster may service a client request without the client detecting that a cluster of servers is processing the request.

Typically, servers or groups of servers operate on a particular network platform, such as Unix or some variation of Unix, and provide a hosting environment for running applications. Each network platform may provide functions ranging from database integration, clustering services, and security to workload management and problem determination. Each network platform typically offers different implementations, semantic behaviors, and application programming interfaces (APIs).

Merely grouping servers together to expand processing power, however, is a limited method of improving efficiency of response times in a network. Thus, increasingly, within a company network, rather than just grouping servers, servers and groups of server systems are organized as distributed resources. There is an increased effort to collaborate, share data, share cycles, and improve other modes of interaction among servers within a company network and outside the company network. Further, there is an increased effort to outsource nonessential elements from one company network to that of a service provider network. Moreover, there is a movement to coordinate resource sharing between resources that are not subject to the same management system, but still address issues of security, policy, payment, and membership. For example, resources on an individual's desktop are not typically subject to the same management system as resources of a company server cluster. Even different administrative groups within a company network may implement distinct management systems.

The problems with decentralizing the resources available from servers and other computing systems operating on different network platforms, located in different regions, with different security protocols and each controlled by a different management system, has led to the development of Grid technologies using open standards for operating a grid environment. Grid environments support the sharing and coordinated use of diverse resources in dynamic, distributed, virtual organizations. A virtual organization is created within a grid environment when a selection of resources, from geographically distributed systems operated by different organizations with differing policies and management systems, is organized to handle a job request.

One important application of a grid environment is that companies implementing an enterprise computing environment can access external grid computing “farms” or vendors. Sending jobs to a grid computing vendor is one way to outsource job execution. The grid computing vendors may provide groups of grid resources accessible for executing grid jobs received from multiple customers.

A current limitation of sending a grid job to a grid computing vendor or other external grid environments is that the grid client sending the job is cut off from monitoring the progress of the job within the grid environment. In particular, the grid computing vendor may estimate beforehand how long a grid job will take to execute or how many resources will be used by the grid job, but the grid client sending the job is cut off from monitoring whether the grid job is actually performing according to the estimations made by the grid computing vendor. Further, a grid client cannot monitor changes in the condition of a grid environment that might effect whether more cost efficient times for running a grid job might be available as grid resources sit idle.

Therefore, in view of the foregoing, there is a need for a method, system, and program for enabling a grid client to initiate and track the real-time status of grid jobs executing within external grid environments. Further, there is a need for a method, system, and program for enabling a grid environment to initiate communication with a grid client about the changes in the condition of a grid environment.

### SUMMARY OF THE INVENTION

In view of the foregoing, the present invention in general provides for automation for access to grids and in particular provides for automated bidding for virtual job requests within a grid environment. Still more particularly, the present invention relates to responding to virtual grid job requests for grid resources by calculating the capacity of grid resources to handle the workload requirements for the virtual requests, where a bid for handling the virtual job request can be generated based on the capacity of the grid environment to handle the workload requirements.

According to one embodiment, a grid client generates a job status query for a grid job passed to an external grid environment. Next, the grid client sends the job status query to the external grid environment via a communication portal. The external grid environment initiates a grid job tracking agent for determining the grid job status within the external grid environment and providing a status response to the grid client. Responsive to receiving the current status from the grid job from the external grid environment, the grid client determines whether the current status meets the expected performance for the grid job, such that the grid client is enabled to monitor whether the external grid environment is actually executing the grid job within the constraints of the expected performance.

The current status of the grid job may indicate, for example, a location of the grid job in a waiting queue within the external grid environment, a location of the grid job using a grid resource, a time the grid job has executed, an amount of resources used by the grid job executing within the external grid environment, and a current cost for the grid job based on an execution status of the grid job. In addition, the current status may indicate a current estimated time for completion, cost for completion, or resource usage for completion.

### BRIEF DESCRIPTION OF THE DRAWINGS

The novel features believed aspect of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 depicts one embodiment of a computer system which may be implemented in a grid environment and in which the present invention may be implemented;

FIG. 2 is block diagram illustrating one embodiment of the general types of components within a grid environment;

FIG. 3 is a block diagram depicting one example of an architecture that may be implemented in a grid environment;

FIG. 4 is a block diagram depicting a grid environment in which a grid client is enabled to access a current status of a grid job passed to an external grid environment;

FIG. 5 is a block diagram depicting a grid client in accordance with the method, system, and program of the present invention;

FIG. 6 is a block diagram depicting a grid job tracking agent in accordance with the method, system, and program of the present invention;

FIG. 7 is a data diagram illustrating the types of data that may be referenced for a particular job by the grid client in accordance with the method, system, and program of the present invention;

FIG. 8 is a data diagram illustrating the types of data that may be referenced for a particular job by the grid job tracking agent in accordance with the method, system, and program of the present invention;

FIG. 9 is a high level logic flowchart of a process and program for handling the client portal that enables a client system to access the current status of a grid job executing in an external grid environment in accordance with the method, system, and program of the present invention; and

FIG. 10 is a high level logic flowchart of a process and program for controlling access to a current grid job status at a grid client system and determining whether to adjust a grid job scheduler based on the current grid job status in accordance with the method, system, and program of the present invention.

### DETAILED DESCRIPTION OF THE PREFERRED EMBODIMENT

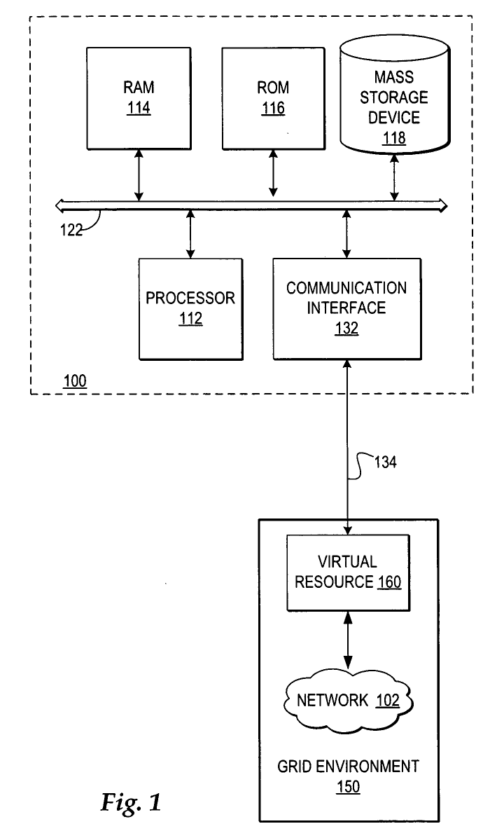

Referring now to the drawings and in particular to FIG. 1, there is depicted one embodiment of a computer system which may be implemented in a grid environment and in which the present invention may be implemented. As will be further described, the grid environment includes multiple computer systems managed to provide resources. Additionally, as will be further described, the present invention may be executed in a variety of computer systems, including a variety of computing systems, mobile systems, and electronic devices operating under a number of different operating systems managed within a grid environment.

In one embodiment, computer system 100 includes a bus 122 or other device for communicating information within computer system 100, and at least one processing device such as processor 112, coupled to bus 122 for processing information. Bus 122 may include low-latency and higher latency paths connected by bridges and adapters and controlled within computer system 100 by multiple bus controllers. When implemented as a server system, computer system 100 typically includes multiple processors designed to improve network servicing power.

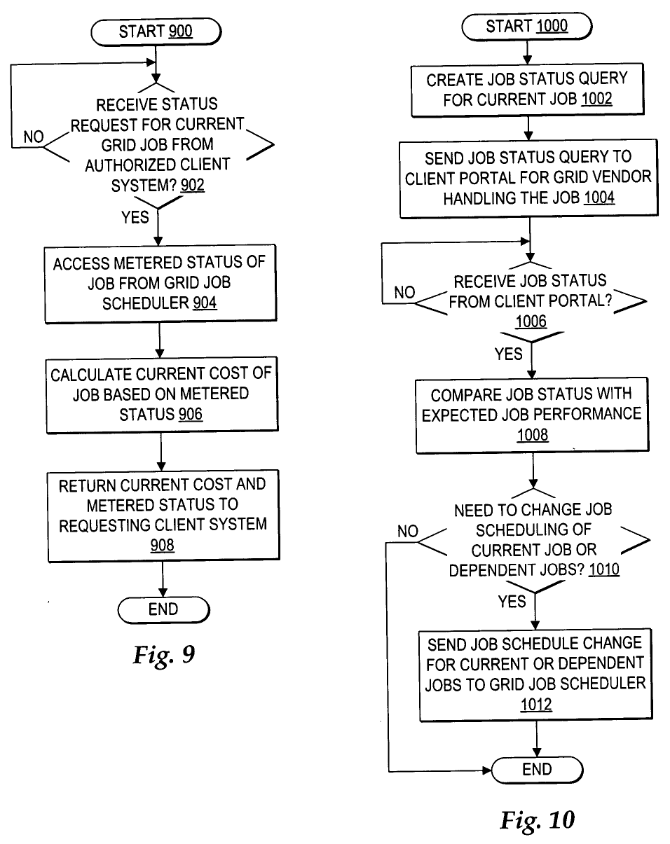

Processor 112 may be a general-purpose processor such as IBM's PowerPC™ processor that, during normal operation, processes data under the control of operating system and application software accessible from a dynamic storage device such as random access memory (RAM) 114 and a static storage device such as Read Only Memory (ROM) 116. The operating system may provide a graphical user interface (GUI) to the user. In one embodiment, application software contains machine executable instructions that when executed on processor 112 carry out the operations depicted in the flowcharts of FIGS. 9 and 10 and other operations described herein. Alternatively, the steps of the present invention might be performed by specific hardware components that contain hardwired logic for performing the steps, or by any combination of programmed computer components and custom hardware components.

The present invention may be provided as a computer program product, included on a machine-readable medium having stored thereon the machine executable instructions used to program computer system 100 to perform a process according to the present invention. The term “machine-readable medium” as used herein includes any medium that participates in providing instructions to processor 112 or other components of computer system 100 for execution. Such a medium may take many forms including, but not limited to, non-volatile media, volatile media, and transmission media. Common forms of non-volatile media include, for example, a floppy disk, a flexible disk, a hard disk, magnetic tape or any other magnetic medium, a compact disc ROM (CD-ROM) or any other optical medium, punch cards or any other physical medium with patterns of holes, a programmable ROM (PROM), an erasable PROM (EPROM), electrically EPROM (EEPROM), a flash memory, any other memory chip or cartridge, or any other medium from which computer system 100 can read and which is suitable for storing instructions. In the present embodiment, an example of a non-volatile medium is mass storage device 118 which as depicted is an internal component of computer system 100, but will be understood to also be provided by an external device. Volatile media include dynamic memory such as RAM 114. Transmission media include coaxial cables, copper wire or fiber optics, including the wires that comprise bus 122. Transmission media can also take the form of acoustic or light waves, such as those generated during radio frequency or infrared data communications.

Moreover, the present invention may be downloaded as a computer program product, wherein the program instructions may be transferred from a remote virtual resource, such as a virtual resource 160, to requesting computer system 100 by way of data signals embodied in a carrier wave or other propagation medium via a network link 134 (e.g. a modem or network connection) to a communications interface 132 coupled to bus 122. Virtual resource 160 may include a virtual representation of the resources accessible from a single system or systems, wherein multiple systems may each be considered discrete sets of resources operating on independent platforms, but coordinated as a virtual resource by a grid manager. Communications interface 132 provides a two-way data communications coupling to network link 134 that may be connected, for example, to a local area network (LAN), wide area network (WAN), or an Internet Service Provider (ISP) that provide access to network 102. In particular, network link 134 may provide wired and/or wireless network communications to one or more networks, such as network 102, through which use of virtual resources, such as virtual resource 160, is accessible as provided by a grid management system 150. Grid management system 150 may be part of multiple types of networks, including a peer-to-peer network, or may be part of a single computer system, such as computer system 100.

As one example, network 102 may refer to the worldwide collection of networks and gateways that use a particular protocol, such as Transmission Control Protocol (TCP) and Internet Protocol (IP), to communicate with one another. Network 102 uses electrical, electromagnetic, or optical signals that carry digital data streams. The signals through the various networks and the signals on network link 134 and through communication interface 132, which carry the digital data to and from computer system 100, are exemplary forms of carrier waves transporting the information. It will be understood that alternate types of networks, combinations of networks, and infrastructures of networks may be implemented.

When implemented as a server system, computer system 100 typically includes multiple communication interfaces accessible via multiple peripheral component interconnect (PCI) bus bridges connected to an input/output controller. In this manner, computer system 100 allows connections to multiple network computers.

Additionally, although not depicted, multiple peripheral components and internal/external devices may be added to computer system 100, connected to multiple controllers, adapters, and expansion slots coupled to one of the multiple levels of bus 122. For example, a display device, audio device, keyboard, or cursor control device may be added as a peripheral component.

Those of ordinary skill in the art will appreciate that the hardware depicted in FIG. 1 may vary. Furthermore, those of ordinary skill in the art will appreciate that the depicted example is not meant to imply architectural limitations with respect to the present invention.

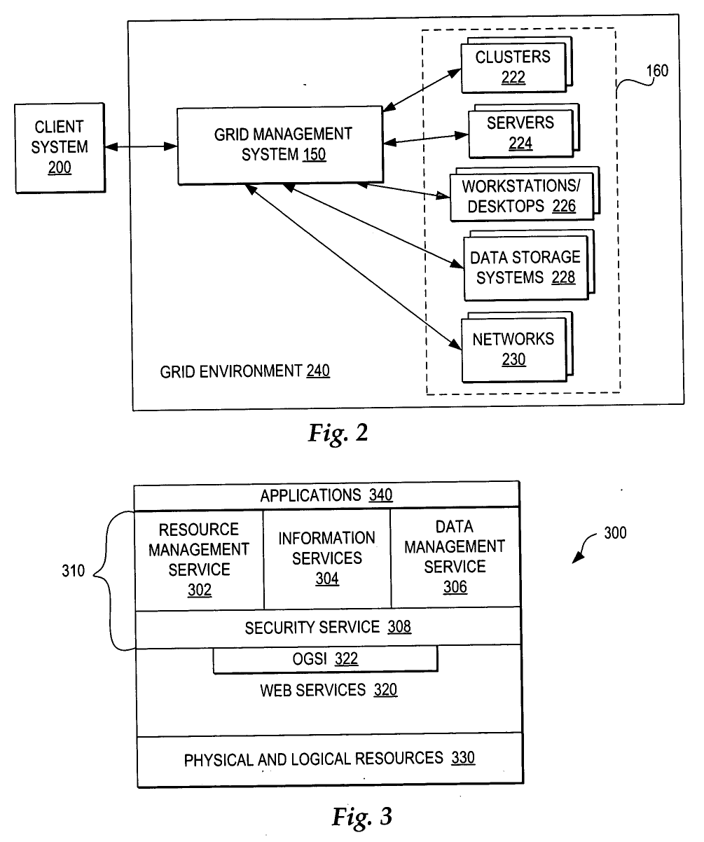

With reference now to FIG. 2, a block diagram illustrates one embodiment of the general types of components within a grid environment. In the present example, the components of a grid environment 240 include a client system 200 interfacing with a grid management system 150 which interfaces with server clusters 222, servers 224, workstations and desktops 226, data storage systems 228, and networks 230. For purposes of illustration, the network locations and types of networks connecting the components within grid environment 240 are not depicted. It will be understood, however, that the components within grid environment 240 may reside atop a network infrastructure architecture that may be implemented with multiple types of networks overlapping one another. Network infrastructure may range from multiple large enterprise systems to a peer-to-peer system to a single computer system. Further, it will be understood that the components within grid environment 240 are merely representations of the types of components within a grid environment. A grid environment may simply be encompassed in a single computer system or may encompass multiple enterprises of systems. Further, a grid environment may be provided by a grid vendor who sells access to running jobs that use resources within the grid environment.

The central goal of a grid environment, such as grid environment 240 is organization and delivery of resources from multiple discrete systems viewed as virtual resource 160. Client system 200, server clusters 222, servers 224, workstations and desktops 226, data storage systems 228, networks 230 and the systems creating grid management system 150 may be heterogeneous and regionally distributed with independent management systems, but enabled to exchange information, resources, and services through a grid infrastructure enabled by grid management system 150. Further, server clusters 222, servers 224, workstations and desktops 226, data storage systems 228, and networks 230 may be geographically distributed across countries and continents or locally accessible to one another.

In the example, grid environment 240 is externally available to client system 200. Client system 200 interfaces with grid environment 240 via grid management system 150. Client system 200 may represent any computing system sending requests to grid management system 150.

While the systems within virtual resource 160 are depicted in parallel, in reality, the systems may be part of a hierarchy of systems where some systems within virtual resource 160 may be local to client system 200, while other systems require access to external networks. Additionally, it is important to note, that systems depicted within virtual resources 160 may be physically encompassed within client system 200.

One function of grid management system 150 is to manage virtual job requests and jobs from client system 200 and control distribution of each job to a selection of computing systems of virtual resource 160 for use of particular resources at the available computing systems within virtual resource 160. From the perspective of client system 200, however, virtual resource 160 handles the request and returns the result without differentiating between which computing system in virtual resource 160 actually performed the request.

To implement grid environment 240, grid management system 150 facilitates grid services. Grid services may be designed according to multiple architectures, including, but not limited to, the Open Grid Services Architecture (OGSA). In particular, grid management system 150 refers to the management environment which creates a grid by linking computing systems into a heterogeneous network environment characterized by sharing of resources through grid services.

In one example, a grid service is invoked when grid management system 150 receives a job status query requesting the current status of a job executing within grid environment 240. The grid service is an agent that queries and calculates the current status of grid jobs within grid environment 240. In addition, when the conditions within grid environment 240 change, a grid service is invoked that controls notifying grid clients of the change in condition. For example, when the cost of performing grid jobs at a later time or at the current time changes, then the grid service notifies grid clients of the change in cost of performing grid jobs.

Referring now to FIG. 3, a block diagram illustrates one example of an architecture that may be implemented in a grid environment. As depicted, an architecture 300 includes multiple layers of functionality. As will be further described, the present invention is a process which may be implemented in one or more layers of an architecture, such as architecture 300, which is implemented in a grid environment, such as the grid environment described in FIG. 2. It is important to note that architecture 300 is just one example of an architecture that may be implemented in a grid environment and in which the present invention may be implemented. Further, it is important to note that multiple architectures may be implemented within a grid environment.

Within the layers of architecture 300, first, a physical and logical resources layer 330 organizes the resources of the systems in the grid. Physical resources include, but are not limited to, servers, storage media, and networks. The logical resources virtualize and aggregate the physical layer into usable resources such as operating systems, processing power, memory, I/O processing, file systems, database managers, directories, memory managers, and other resources.

Next, a web services layer 320 provides an interface between grid services 310 and physical and logical resources 330. Web services layer 320 implements service interfaces including, but not limited to, Web Services Description Language (WSDL), Simple Object Access Protocol (SOAP), and eXtensible mark-up language (XML) executing atop an Internet Protocol (IP) or other network transport layer. Further, the Open Grid Services Infrastructure (OSGI) standard 322 builds on top of current web services 320 by extending web services 320 to provide capabilities for dynamic and manageable Web services required to model the resources of the grid. In particular, by implementing OGSI standard 322 with web services 320, grid services 310 designed using OGSA are interoperable. In alternate embodiments, other infrastructures or additional infrastructures may be implemented a top web services layer 320.

Grid services layer 310 includes multiple services. For example, grid services layer 310 may include grid services designed using OGSA, such that a uniform standard is implemented in creating grid services. Alternatively, grid services may be designed under multiple architectures. Grid services can be grouped into four main functions. It will be understood, however, that other functions may be performed by grid services.

First, a resource management service 302 manages the use of the physical and logical resources. Resources may include, but are not limited to, processing resources, memory resources, and storage resources. Management of these resources includes scheduling jobs, distributing jobs, and managing the retrieval of the results for jobs. Resource management service 302 monitors resource loads and distributes jobs to less busy parts of the grid to balance resource loads and absorb unexpected peaks of activity. In particular, a user may specify preferred performance levels so that resource management service 302 distributes jobs to maintain the preferred performance levels within the grid.

Second, information services 304 manages the information transfer and communication between computing systems within the grid. Since multiple communication protocols may be implemented, information services 304 manages communications across multiple networks utilizing multiple types of communication protocols.

Third, a data management service 306 manages data transfer and storage within the grid. In particular, data management service 306 may move data to nodes within the grid where a job requiring the data will execute. A particular type of transfer protocol, such as Grid File Transfer Protocol (GridFTP), may be implemented.

Finally, a security service 308 applies a security protocol for security at the connection layers of each of the systems operating within the grid. Security service 308 may implement security protocols, such as Open Secure Socket Layers (SSL), to provide secure transmissions. Further, security service 308 may provide a single sign-on mechanism, so that once a user is authenticated, a proxy certificate is created and used when performing actions within the grid for the user.

Multiple services may work together to provide several key functions of a grid computing system. In a first example, computational tasks are distributed within a grid. Data management service 306 may divide up a computation task into separate grid services requests of packets of data that are then distributed by and managed by resource management service 302. The results are collected and consolidated by data management system 306. In a second example, the storage resources across multiple computing systems in the grid are viewed as a single virtual data storage system managed by data management service 306 and monitored by resource management service 302.

An applications layer 340 includes applications that use one or more of the grid services available in grid services layer 310. Advantageously, applications interface with the physical and logical resources 330 via grid services layer 310 and web services 320, such that multiple heterogeneous systems can interact and interoperate.

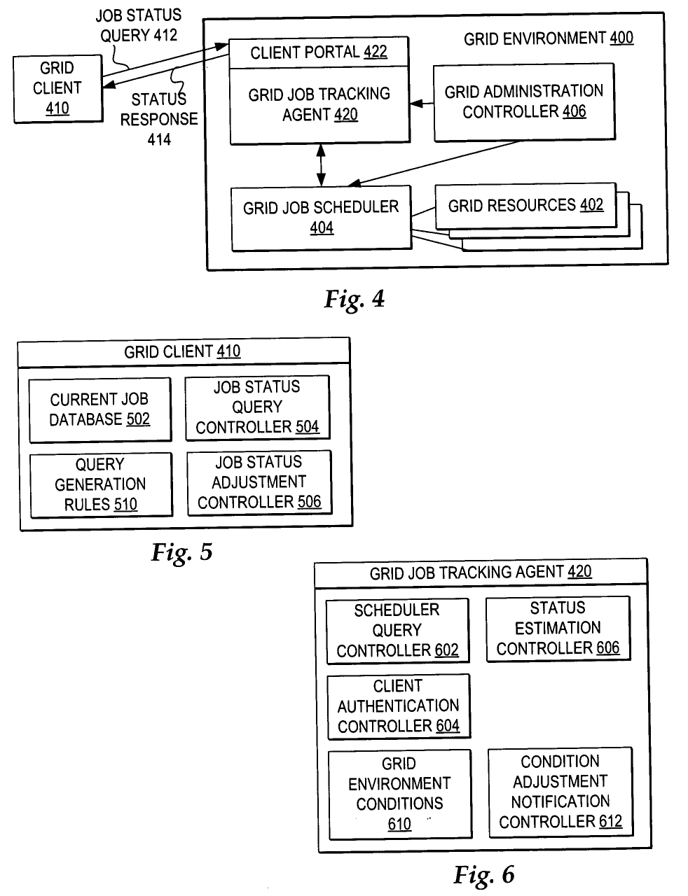

With reference now to FIG. 4, there is depicted a block diagram of a grid environment in which a grid client is enabled to access a current status of a grid job passed to an external grid environment. In one embodiment, the grid management system for grid environment 400 includes a grid job tracking agent 420, a grid administration controller 406, and a grid job scheduler 404. It will be understood that additional agents, services, and controllers may be implemented within the grid management system for grid environment 400. In one embodiment, grid environment 400 is an external grid environment with resources available for use by contracting with the grid vendor administrating grid environment 400.

In addition, the grid management system for grid environment 400 includes a client portal 422 through which external grid clients, such as grid client 410, communicate with grid environment 400. Client portal 422 may also enable a bi-directional communication channel between grid client 410 and grid environment 400 to enable communication about the current status of jobs running within grid environment 400 and the current condition of grid environment 400. As illustrated, client portal 422 enables access to grid job tracking agent 420, however, it will be understood that in alternate embodiments, client portal 422 enables access to other services and agents within grid environment 400.

In the example illustrated, it is assumed that grid client 410 has passed a grid job to grid environment 400 and that grid job scheduler 404 has scheduled the grid job for execution. In one embodiment, an estimated time for completion of the grid job within grid environment 400 is pre-determined. In another embodiment, an estimated resource usage for completion of the grid job within grid environment 400 is pre-determined. Further, in another embodiment, a cost for performing the grid job may be based on the amount of time or the amount of resources used.

According to an advantage of the invention, grid client 410 sends a job status query 412 via a network to client portal 422. Client portal 422 passes the job status query to grid job tracking agent 420. Grid job tracking agent 420 may determine whether grid client 410 is authorized to access current job status information. In addition, grid job tracking agent 420 may query grid job scheduler 404 for current metered information for the job. Grid job tracking agent 420 then uses the current metered information to calculate a current cost and other status indicators of a job and returns the current cost and other status indicators as a status response 414 to grid client 410. It is important to note that job status query 412 may request particular types of status indicators, such that status response 414 is tailored to the types of status information requested by grid client 410.

In particular, grid job scheduler 404 may schedule jobs for execution within grid resources 402. Then, when a job is executing, grid job scheduler 404 may maintain a meter of the current usage of grid resources 402 and the amount of time a job has been executing. It will be understood that grid job scheduler 404 may schedule jobs for distribution across multiple grid environments and may schedule the specific resources for a job to meet quality and performance requirements.

In another embodiment, grid job tracking agent 420 monitors when conditions change within grid environment 400 and initiates communication with grid client 410 to notify grid client 410 of changes to the grid environment conditions. In one example, grid job tracking agent 420 may determine that jobs are currently delayed or that grid resources are currently sitting idle by querying grid job scheduler 404 and notify grid client 410 of the changes to condition of the grid environment. In another example, when grid administration controller 406 adjusts the conditions for grid environment 400 by adjusting costs or other parameters, grid job tracking agent 420 notifies grid client 410 of the change to the condition of the grid environment. Additionally, grid job tracking agent 420 may tailor the notification of grid environment condition changes according to the notification preferences of each grid client.

Responsive to receiving a status response 414 or a notification that conditions within grid environment 400 have changed, grid client 410 may determine whether to change the scheduling or other characteristics of a job. In one example, if status response 414 indicates that the job is not currently performing to meet cost or performance expectations, grid client 410 may cancel or reschedule the job. In another example, if grid client 410 is notified of changes to grid environment conditions, then grid client 410 may decide to reschedule a current job or to reschedule future jobs to take advantage of times when better performance or lower costs are available within the grid environment.

In one example, a grid job currently executing within grid environment 400 was originally estimated to take six hours to complete. After four hours from the start time of the grid job, grid client 410 sends a job status query to grid job tracking agent 420 requesting the current estimated time for completion based on the actual performance of the grid job within the grid environment. Grid job tracking agent 420 access the current metering for the grid job and requests a new time estimation from grid job scheduler 404. The new estimated time for completion of the grid job is ten hours. Grid client 410 receives the new time estimation and checks whether any jobs that are dependent upon the currently executing job need to be alerted to the new time estimation or if any of the dependent jobs need to be rescheduled.

In another example, the cost of a grid job currently executing within grid environment 400 will be based on the amount of resources used by the grid job. Grid client 410 sends a job status query requesting the current resource usage. Grid job tracking agent 420 accesses the metered amount of resource usage from grid job scheduler 404 and calculates the current cost based on the current amount of resources used. Grid client 410 receives the current cost and determines that the current cost is approaching a maximum cost allowed for the grid job. The grid client 410 decides request an adjustment in the priority of the grid job to receive a lower cost per resource usage, but a later completion time, so the job can complete without exceeding the maximum cost allowed for the grid job.

In yet another example, a grid vendor providing grid environment 400 adjusts the current grid environment conditions by offering a discount for jobs scheduled to run within a typically low volume period of time. For example, the grid vendor may currently charge $100 per CPU second during daytime hours, but is offering a discount of $70 per CPU second during nighttime hours. Grid job tracking agent 420 notifies grid client 410 of the change in condition of running jobs within the grid environment. Grid client 410 then decides to suspend a job that is currently executing within grid environment 400 by adjusting the priority of the job and reschedule other jobs waiting to execute within grid environment 400 so that the suspended and rescheduled jobs execute within the discount time period.

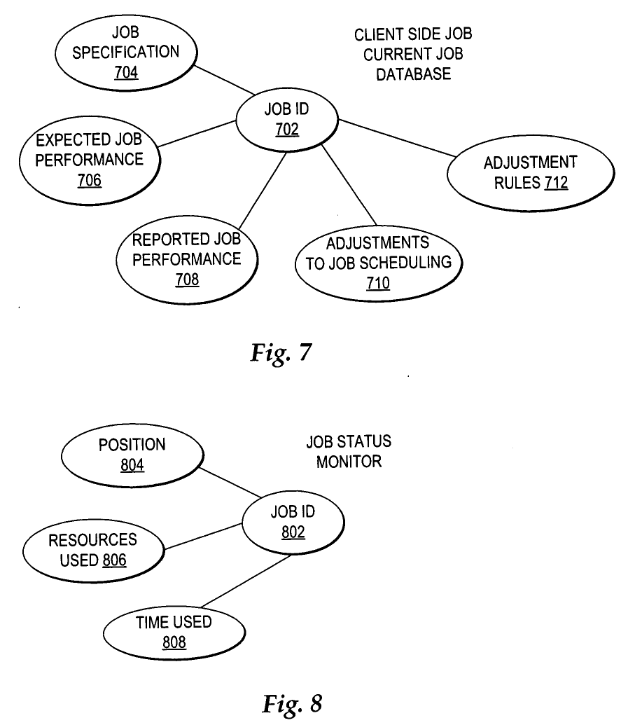

Referring now to FIG. 5, there is depicted a block diagram of a grid client in accordance with the method, system, and program of the present invention. As depicted, grid client 410 includes a current job database 502. Current job database 502 includes the job identifier and specifications for jobs current scheduled for execution within a grid environment. In particular, as will be further described with reference to FIG. 7, the job specifications may include the expected performance characteristics of a job executing within a grid environment.

In one embodiment, job status query controller 504 generates job status queries for jobs within current job database 502 based on query generation rules 510. Query generation rules 510 may specify the conditions under which job status queries should be generated for rules. For example, a query generation rule may specify that job status queries should be generated for jobs estimated to cost more than a fixed price when the job should be 50% complete. In another example, a query generation rule may specify that jobs status queries should be generated for jobs that are not returned within the expected performance time.

In another embodiment, job status query controller 504 provides an interface through which a user may specify a job status query for submission to a grid job tracking agent. Further, job status query controller 504 may prompt a user to specify a job status query or approve an automatically generated job status query.

Job status query controller 504 may generate a query requesting all current status information or particular types of status information. For example, a job status query may specifically request a current time estimate for completion, a current time executing, a current resource usage, a current cost, and other specific status characteristics.

A job status adjustment controller 506 within grid client 410 receives the status responses from the grid job tracking agent and determines whether to adjust the scheduling of a grid job based on the current status. First, job status adjustment controller 506 may compare the status response with the expected job performance. If the status response indicates that the job does not or will not meet the expected job performance, then job status adjustment controller 506 compares the results with adjustment rules for the job or for the client. As further described with reference to FIG. 7, the adjustment rules may indicate whether to suspend a job, cancel a job, or proceed with a job, for example, based on the current status of a job. If a scheduling adjustment is needed, then job status adjustment controller 506 may update the job scheduling for the job in current job database 502 and send a scheduling adjustment request to the grid scheduler within the grid environment handling the job. Alternatively, the grid job tracking agent may provide the portal through which scheduling adjustment requests are received in a grid environment.

Further, job status adjustment controller 506 may receive grid environment condition changes and determine whether to adjust the scheduling of a grid job based on the current grid environment conditions. For example, if grid environment conditions change so that a currently executing job could be completed at a lower cost at a later time, then job status adjustment controller 506 may determine whether the priority of the job can be changed to take advantage of the lower cost time period. In another example, if a grid job within current job database 502 is scheduled for a 9 PM start, but the grid specification adjustment received at 5 PM indicates that rates are now less expensive if the job starts at 10 PM, job status adjustment controller 506 determines whether the job can be delayed and if so, automatically sends a reschedule request for the job to the grid environment.

In addition, job status adjustment controller 506 may provide an interface through which a user can designate job status adjustment criteria and request job scheduling changes based on current job status and grid environment specification changes. Further, job status adjustment controller 506 may prompt a user to approve a job scheduling change and may notify users of job scheduling changes.

With reference now to FIG. 6, there is depicted a block diagram of a grid job tracking agent in accordance with the method, system, and program of the present invention. As depicted, grid job tracking agent 420 includes a client authentication controller 604. Client authentication controller 604 may authenticate the identity and authorization for accessing status information for the grid client submitting a job status query to grid job tracking agent 420. In addition, a grid client may access grid job tracking agent 420 through a secure channel established by client authentication controller 604.

In addition, grid job tracking agent 420 includes a scheduler query controller 602. Scheduler query controller 602 receives job status queries from the grid client and returns a status response for the grid job. In particular, scheduler query controller 602 controls accesses to current status values tracked by grid job scheduler 404, where current status values may include, for example, a processing time and a resource usage amount.

A status estimation controller 606 within grid job tracking agent 420 may estimate a current cost for a job based on the current status values and the billing and the grid environment specifications for the job. In addition, status estimation controller 606 may adjust the current status values reported by the grid job scheduler into a unit understandable by the grid client. The scheduler query controller returns the estimated current cost and adjusted current status values in the status response to the grid client.

In particular, status estimation controller 606 accesses grid environment conditions 610 to determine the grid environment specifications for a job. Grid environment conditions 610 may include the billing and performance specifications for a grid environment. Billing and performance specifications may be further classified according to time, time, client, or job for which the specifications are applicable.

In addition, status estimation controller 606 may estimate or communicate with the grid job scheduler to estimate a time for completion of a grid job. For example, while a grid job may originally be estimated to require six hours to complete, status estimation controller 606 may determine, based on the amount of resources usage compared with the total estimated resource usage, how much estimated time actually remains for the job to complete.

A condition adjustment notification controller 612 detects changes to the grid environment conditions 610 that may be important to a grid client. For example, if a cost per hour is adjusted based on current volume so that the price per job increases during the peak period within grid environment conditions 610, condition adjustment notification controller 612 may communicate with grid clients to provide a notification of the adjustment.

Referring now to FIG. 7, there is depicted a data diagram illustrating the types of data that may be referenced for a particular job by the grid client in accordance with the method, system, and program of the present invention. As depicted, the data associated with a job is tracked in association with a job identifier (ID) 702. It is important to note that each of the types of data illustrated in associated with job ID 702 may include multiple fields of data and may be stored in multiple types of data storage controllers and entities.

In the example, a job specification 704 may be associated with job ID 702, where the job specification may include, for example, the job performance requirements for a job. Job specification 704 may also include, for example, the job performance specification submitted to multiple grid vendors to receive bids for the grid job.

In addition, expected job performance 706 may be associated with job ID 702, where the expected job performance may include, for example, the promised job performance by the grid vendor handling the job. Expected job performance 706 may be based on multiple factors including, but not limited to, a processing time expectation, a resource usage expectation, and a total cost expectation.

Reported job performance 708 associated with job ID 702 may include the current reported status data from the grid job tracking agent. In addition, a reported job performance 708 may include status information calculated by the grid client based on the status data received from the grid job tracking agent.

Adjustment rules 712 specify the status conditions required for adjusting a job schedule. If a status condition is true, then a job may be suspended, canceled, or continued, for example. Status conditions may be based on the current status of a job or based upon changes in the grid specifications.

Job scheduling adjustments 710 associated with job ID 702 may include any adjustments to the scheduling of the job requested by the grid client, where scheduling adjustments may be determined based on adjustment rules 712.

With reference now to FIG. 8, there is depicted a data diagram illustrating the types of data that may be referenced for a particular job by the grid job tracking agent in accordance with the method, system, and program of the present invention. As depicted, the information received about a job by the grid job tracking agent for a job ID 802 such as a position 804, an amount of resources used 806, and an amount of time used 808. The position 804 may indicate whether a grid job is still within a queue or is being executed and may further specify the current execution location of the grid job within the grid environment. The resources used 806 may indicate which resources have been used for processing the job, particularly if the cost of a job is determined by metering the amount of resources used by a job. The time used 808 may indicate the amount of time that a job has been executing. As previously described, the grid job tracking agent may calculate a current cost of a grid job and estimate the amount of resources or time still remaining for completion of the job. Further, it will be understood that additional information may be tracked by the grid scheduler and passed to the grid job tracking agent for

Referring now to FIG. 9, there is depicted a high level logic flowchart of a process and program for handling the client portal that enables a client system to access the current status of a grid job executing in an external grid environment in accordance with the method, system, and program of the present invention. As depicted, the process starts at block 900 and thereafter proceeds to block 902. Block 902 depicts a determination whether a status request for a current grid job is received from an authorized grid client system. Once a status request for a current grid job is received from an authorized grid client system, then the process passes to block 904. Block 904 depicts accessing the metered status of the requested job from the grid job scheduler. Next, block 906 depicts calculating the current cost of the job based on the metered status. In addition, metered status characteristics, such as time and resource use, may be converted into a unit preferred for distribution to a grid client system. Further, a current estimate of the time or resources required to complete a job may be calculated and included in the status response. Thereafter, block 908 depicts returning the current cost and metered status to the request grid client system, and the process ends.

With reference now to FIG. 10, there is depicted a high level logic flowchart of a process and program for controlling access to a current grid job status at a grid client system and determining whether to adjust a grid job scheduler based on the current grid job status in accordance with the method, system, and program of the present invention. As depicted, the process starts at block 1000 and thereafter proceeds to block 1002. Block 1002 depicts creating a job status query for a current job. Next, block 1004 depicts sending the job status query to the client portal for the grid vendor handling the job. Thereafter, block 1006 depicts a determination whether a job status is received from the client portal. If a job status is not received, then the process iterates at block 1006 for a particular time period before an error is returned. If a job status is received, then the process passes to block 1008.

Block 1008 depicts comparing the current job status with the expected job performance. In addition, the current job status may be compared with a requested job performance. Next, block 1010 depicts a determination whether there is a need to change the job scheduling of the current jobs or any jobs dependent on the completion of the current job. If there is not need to change the job scheduling, then the process ends. If there is a need to change the job scheduling, then the process passes to block 1012. Block 1012 depicts sending a job schedule change for the current job or a dependent job to the grid job scheduler for the job, and the process ends.

While the invention has been particularly shown and described with reference to a preferred embodiment, it will be understood by those skilled in the art that various changes in form and detail may be made therein without departing from the spirit and scope of the invention.

What is claimed is:

1. A computer-implemented method for enabling a client to monitor a current status of a grid job passed to an external grid environment, comprising:
generating a job status query of a grid job passed to an external grid environment;
sending said job status query to said external grid environment via a communication portal into said external grid environment; and
responsive to receiving a current status for said grid job from said external grid environment, determining whether said current status meets an expected performance for said grid job, such that said grid client is enabled to monitor whether said external grid environment is executing said grid job within a constraint of said expected performance.

2. The computer-implemented method according to claim 1 for enabling a client to monitor a current status of a grid job passed to an external grid environment, comprising:
responsive to receiving said job status query at said external grid environment via said communication portal, initiating a grid service within said external grid environment to track said current status of said grid job executing within said external grid environment.

3. The computer-implemented method according to claim 1 for enabling a client to monitor a current status of a grid job passed to an external grid environment, wherein said current status indicates at least one from among a location of said grid job in a waiting queue, a location of said grid job using a grid resource, a time said grid job has executed, an amount of resources used by said grid job executing within said external grid environment, and a current cost for said grid job based on an execution status of said grid job.

4. The computer-implemented method according to claim 1 for enabling a client to monitor a current status of a grid job passed to an external grid environment, wherein determining whether said current status meets an expected performance for said grid job, further comprises:
comparing said current status with said expected performance, wherein said expected performance is a performance agreement issued by said external grid environment.

5. The computer-implemented method according to claim 1 for enabling a client to monitor a current status of a grid job passed to an external grid environment, further comprising:
responsive to determining that said current status does not meet said performance requirements, selecting a job adjustment response comprising at least one from among suspending said grid job, canceling said grid job, or continuing said grid job with an adjusted priority.

6. The computer-implemented method according to claim 1 for enabling a client to monitor a current status of a grid job passed to an external grid environment, further comprising:
responsive to determining that said current status does not meet said performance requirements, adjusting a schedule of at least one dependent job, wherein execution of said dependent job is dependent upon the performance of said grid job in said external grid environment.

7. The computer-implemented method according to claim 1 for enabling a client to monitor a current status of a grid job passed to an external grid environment, further comprising:
responsive to receiving at said grid client via said communication portal a notification of a change in condition of said external environment, determining whether to send a job adjustment response for at least one from among said grid job and a future grid job to meet said expected performance within said change in condition of said external environment.

8. A system for enabling a client to monitor a current status of a grid job passed to an external grid environment, comprising:
a grid client system communicatively connected to an external grid environment via a communication portal into said external grid environment;
said grid client system further comprising:
means for generating a job status query of a grid job passed to said external grid environment;
means for sending said job status query to said external grid environment via said communication portal; and
means, responsive to receiving a current status for said grid job from said external grid environment, for determining whether said current status meets an expected performance for said grid job.

9. The system according to claim 8 for enabling a client to monitor a current status of a grid job passed to an external grid environment, said external grid environment further comprising:
means, responsive to receiving said job status query at said external grid environment via said communication portal, for initiating a grid service within said external grid environment to track said current status of said grid job executing within said external grid environment.

10. The system according to claim 8 for enabling a client to monitor a current status of a grid job passed to an external grid environment, wherein said current status indicates at least one from among a location of said grid job in a waiting queue, a location of said grid job using a grid resource, a time said grid job has executed, an amount of resources used by said grid job executing within said external grid environment, and a current cost for said grid job based on an execution status of said grid job.

11. The system according to claim 8 for enabling a client to monitor a current status of a grid job passed to an external grid environment, wherein said means for determining whether said current status meets an expected performance for said grid job, further comprises:
means for comparing said current status with said expected performance, wherein said expected performance is a performance agreement issued by said external grid environment.

12. The system according to claim 8 for enabling a client to monitor a current status of a grid job passed to an external grid environment, said grid client further comprising:
means, responsive to determining that said current status does not meet said performance requirements, for selecting a job adjustment response comprising at least one from among suspending said grid job, canceling said grid job, or continuing said grid job with an adjusted priority.

13. The system according to claim 8 for enabling a client to monitor a current status of a grid job passed to an external grid environment, said grid client further comprising:
means, responsive to determining that said current status does not meet said performance requirements, for adjusting a schedule of at least one dependent job, wherein execution of said dependent job is dependent upon the performance of said grid job in said external grid environment.

14. The system according to claim 8 for enabling a client to monitor a current status of a grid job passed to an external grid environment, said grid client further comprising:
means, responsive to receiving at said grid client via said communication portal a notification of a change in condition of said external environment, for determining whether to send a job adjustment response for at least one from among said grid job and a future grid job to meet said expected performance within said change in condition of said external environment.

15. A computer program product, residing on a computer readable medium, for enabling a client to monitor a current status of a grid job passed to an external grid environment, comprising:
means for controlling generation of a job status query of a grid job passed to an external grid environment;
means for enabling transmission of said job status query to said external grid environment via a communication portal into said external grid environment; and
means, responsive to receiving a current status for said grid job from said external grid environment, controlling a determination whether said current status meets an expected performance for said grid job.

16. The computer program product according to claim 15 for enabling a client to monitor a current status of a grid job passed to an external grid environment, further comprising:
means for enabling receipt of said current status, wherein said current status indicates at least one from among a location of said grid job in a waiting queue, a location of said grid job using a grid resource, a time said grid job has executed, an amount of resources used by said grid job executing within said external grid environment, and a current cost for said grid job based on an execution status of said grid job.

17. The computer program product according to claim 15 for enabling a client to monitor a current status of a grid job passed to an external grid environment, wherein said means for controlling a determination whether said current status meets an expected performance for said grid job, further comprises:
means for controlling a comparison of said current status with said expected performance, wherein said expected performance is a performance agreement issued by said external grid environment.

18. The computer program product according to claim 15 for enabling a client to monitor a current status of a grid job passed to an external grid environment, further comprising:
means, responsive to determining that said current status does not meet said performance requirements, for controlling a selection of a job adjustment response comprising at least one from among suspending said grid job, canceling said grid job, or continuing said grid job with an adjusted priority.

19. The computer program product according to claim 15 for enabling a client to monitor a current status of a grid job passed to an external grid environment, further comprising:
means, responsive to determining that said current status does not meet said performance requirements, for controlling an adjustment of a schedule of at least one dependent job, wherein execution of said dependent job is dependent upon the performance of said grid job in said external grid environment.

20. The computer program product according to claim 15 for enabling a client to monitor a current status of a grid job passed to an external grid environment, further comprising:
means, responsive to receiving at said grid client via said communication portal a notification of a change in condition of said external environment, for controlling a determination whether to send a job adjustment response for at least one from among said grid job and a future grid job to meet said expected performance within said change in condition of said external environment.
